(19) United States
(12) Patent Application Publication
(10) Pub. No.: US 2025/0384108 A1
(43) Pub. Date: Dec. 18, 2025

(54) STATISTICAL ANALYSIS FOR PREDICTING RARE FAILURE EVENTS OF A CIRCUIT

(71) Applicant: International Business Machines Corporation, Armonk, NY (US)

(72) Inventor: Ning Lu, Essex Junction, VT (US)

(21) Appl. No.: 18/743,308

(22) Filed: Jun. 14, 2024

(51) Int. Cl. G06F 17/18; G06F 11/00

(52) U.S. Cl. CPC G06F 17/18; G06F 11/008

(57) ABSTRACT

A computer-implemented method that includes identifying statistical parameters in a model set that affects a given figure of merit for a circuit. The method further includes selecting a set of distribution enlargement ratio values. The method further includes, for each of the set of distribution enlargement ratio values: for each identified statistical parameter, maintain a nominal value and increase a standard deviation; generating sets of random samples using standard deviation enlarged statistical distributions and performing a Monte Carlo simulation with N runs; and among N figure-of-merit values, count the number of figure-of-merit values that fall into a failure region, and calculate a failure probability value of the Monte Carlo run with N events. The method further includes fitting a logarithm of failure probability values for the failure region to a curve defined by a probability scaling relation and extrapolating the curve to predict a rare failure probability for the circuit.

### BACKGROUND

The present disclosure relates to computing environments, and more specifically, to statistical analysis for predicting rare failure events of a circuit.

Circuits can experience failures as a result of design or manufacturing defects. It is useful to predict when such failures may occur. Statistical analysis techniques can be used to predict circuit failures, enabling the circuits to be assessed for reliability and performance under various conditions.

### SUMMARY

According to an embodiment, a computer-implemented method is provided. The method includes identifying statistical parameters in a model set that affects a given figure of merit for a circuit. The method further includes selecting a set of K distribution enlargement ratio values s₁, s₂, . . . , sₖ. The method further includes, for each of the set of K distribution enlargement ratio values: for each identified statistical parameter, maintain a nominal value and increase a standard deviation by a ratio given by the said distribution enlargement ratio value to generate a standard deviation enlarged statistical distribution; generating sets of random samples using the standard deviation enlarged statistical distributions and performing a Monte Carlo simulation with N runs using distribution-widened sets of random samples, which returns N figure-of-merit values; and among the N figure-of-merit values, count the number of figure-of-merit values that fall into a failure region, and calculate a failure probability value of the Monte Carlo run with N events; fitting a logarithm of K failure probability values P for the failure region, InP₁, InP₂, . . . , InP_{K}, to a curve defined by a probability scaling relation: ln P_{f}(s)=a+b. In

$$s + \frac{c}{{s}^{2}} + g \cdot s ,$$

where s is a distribution enlargement ratio and a, b, c, and g are fitting parameters; and extrapolating the curve to s=1 to predict a rare failure probability for the circuit.

Other embodiments described herein implement features of the above-described method in computer systems and computer program products.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 illustrates a computing environment, according to an embodiment;

FIG. 2 illustrates a flow diagram of a method for predicting rare failure events of a circuit using statistical analysis, according to an embodiment;

FIG. 3 illustrates a flow diagram of a method for predicting rare failure events of a circuit using statistical analysis, according to an embodiment; and

FIG. 4A illustrates a table of relative error of log₁₀ P_{f} (1) for predicting a logarithm of a six-sigma failure, according to an embodiment; and

FIG. 4B illustrates a table of relative error of P_{f}(1) for predicting a six-sigma failure probability, according to an embodiment.

### DETAILED DESCRIPTION

One or more embodiments described herein provide for statistical analysis for predicting rare failure events of a circuit, such as a logic gate, a static random access memory (SRAM) device, and/or the like, including combinations and/or multiples thereof. A rare failure event is a failure that occurs in only a small number of cases (e.g., occurs at a rate defined as a rare failure rate). A rare failure rate refers to the frequency at which highly uncommon and infrequent (e.g., rare) failures occur. For example, a rare failure event may occur as follows: p_{4-sigma}=(1 in 3.16×10⁴) (referred to as a 4-sigma failure event, or simply nσ=4σ); P_{5-sigma}=(1 in 3.49×10⁶) (a 5-sigma failure event or simply nσ=5σ); p_{6-sigma}=(1 in 1.01×10⁹) (a 6-sigma failure event or simply no=6σ); P_{7-sigma}=(1 in 7.81×10¹¹) (a 7-sigma failure event or simply no=70); P_{7-sigma}=(1 in 1.61×10¹⁵) (an 8-sigma failure event or nσ=8σ); P_{9-sigma}=(1 in 8.86×10¹⁸) (a 9-sigma failure event nσ=90); p_{10-sigma}=(1 in 1.31×10²³) (a 10-sigma failure event nσ=100); p_{11-sigma}=(1 in 5.23×10²⁷) (an 11-sigma failure event or nσ=11σ); or p_{12-sigma}=(1 in 5.63×10³²) (a 12-sigma failure event or nσ=12σ).

It can be difficult to predict a failure event in such rare cases. Specifically, it can be difficult to calculate the probability of a rare failure event occurring. For example, a scaled sigma sampling (SSS) approach can be used to predict failures. The SSS approach first artificially increases the variations of statistical parameters that affect the figure-of-merit (FOM) of a circuit such that the number of events in the failure region of the circuit is increased. The SSS method repeats this step several times, each time the ratio of variation increase is different. Namely, in a first Monte Carlo run, the ratio of variation increase used is s₁ (s₁>1); in a second Monte Carlo run, the ratio of variation increase used is s₂ (s₂>1, s₂≠s₁); etc. In this way, the total number of runs that need to be performed could be significantly reduced. Such multiple Monte Carlo runs generate multiple artificially increased failure probabilities. Due to the nature of Monte Carlo statistics, each failure probability could be affected by the sampling error used in the Monte Carlo sampling process. The SSS approach then compensates the artificially increased failure probabilities through a curve fitting process for the logarithm of the above obtained multiple failure probabilities. Specifically, the existing SSS approach utilizes the following relation for calculating the probability of a rare failure:

$$ln {P}_{f} ( s ) = a + b \cdot ln s + \frac{c}{{s}^{2}} ,$$

where s is a scaling factor (also referred to herein as a distribution enlargement ratio), and a, b, and c are fitting parameters. After obtaining the fitting parameters a, b, and c through the curve fitting process for ln P_{f}(s), the final step of the existing SSS approach is an extrapolation: Setting s=1 in the above relation. It has been found that such a curve-fitting and extrapolation process gives a good result for the logarithm of the extrapolated failure probability but a bad result for the extrapolated failure probability itself due to the fact that the failure probability itself is a very small value.

Consider a circuit with an exact failure probability of P_{exact}=10⁻⁷. It is clear that log₁₀ P_{exact}=−7.0. (i) If a set of Monte Carlo simulations followed by a curve-fitting process and an extrapolation step yields a log₁₀ Pₑₓₜᵣₐₚₒₗ with only a 1% error, namely, log₁₀ Pₑₓₜᵣₐₚₒₗ=log₁₀ P_{f} (1)=−7.07, then the extrapolated failure probability itself is Pₑₓₜᵣₐₚₒₗ=8.51×10⁻⁸. It is evident that the error on the failure probability itself is-15% here. (ii) If another set of Monte Carlo simulations followed by a curve-fitting process and an extrapolation step yields a log₁₀ Pₑₓₜᵣₐₚₒₗ with a 2% error, namely, log₁₀ Pₑₓₜᵣₐₚₒₗ=log₁₀ P_{f} (1)=−7.14, then the extrapolated failure probability itself is Pₑₓₜᵣₐₚₒₗ=P_{f} (1)=7.24×10⁻⁸. It is evident that the error on the failure probability itself becomes-28% here.

Consider another circuit with an exact failure probability of P_{exact}=10⁻⁹ (a 6-sigma failure event). It is clear that log₁₀ P_{exact}=−9.0. (i) If a set of Monte Carlo simulations followed by a curve-fitting process and an extrapolation step yields a log₁₀ Pₑₓₜᵣₐₚₒₗ with only a 1% error, i.e., log₁₀ Pₑₓₜᵣₐₚₒₗ=log₁₀ P_{f} (1)=−9.09, then the extrapolated failure probability itself is Pₑₓₜᵣₐₚₒₗ=P_{f} (1)=8.13×10⁻¹⁰. It is evident that the error on the failure probability itself is −19% in this example. (ii) If a second set of Monte Carlo simulations followed by a curve-fitting process and an extrapolation step yields a log₁₀ Pₑₓₜᵣₐₚₒₗ with a 2% error, namely, log₁₀ Pₑₓₜᵣₐₚₒₗ=log₁₀ P_{f} (1)=−9.18, then the extrapolated failure probability itself is Pₑₓₜᵣₐₚₒₗ=P_{f}(1)=6.61×10⁻¹⁰. It is evident that the error on the failure probability itself becomes-34% here.

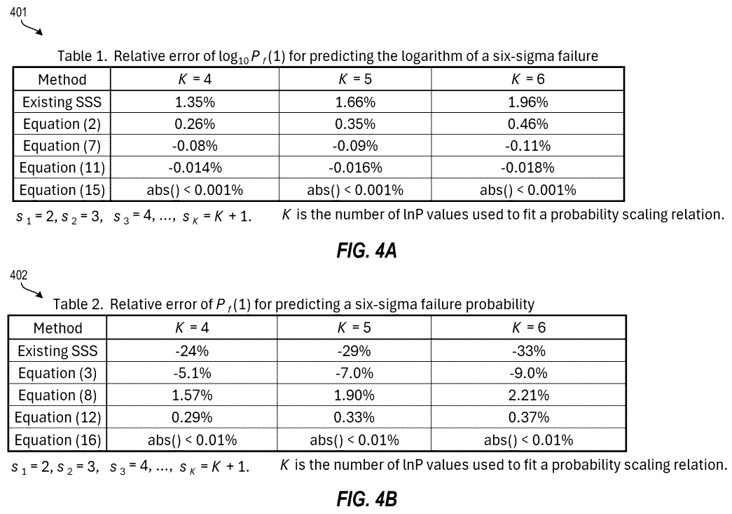

The above examples illustrate that there is room to improve the accuracy of the existing SSS approach. Consider the following examples that illustrate that, even without any sampling error from a set of Monte Carlo simulations (i.e., when the confidence intervals are all zero), the error on extrapolated log₁₀ P_{f}(1) can reach 1% and 2%. Consider a situation where failure rates P(1), P(s₁), P(s₂), P(s₃), etc. can be calculated accurately. There are M independent Gaussian random variables. The value of M can be 2, 3, 10, 100, 1000, 10000, etc. The success-failure boundaries of a figure-of-merit are a set of planes in the M dimensional space. The failure rates here are like the failure rates in a one-dimensional space with a Gaussian distribution and can be calculated exactly using the error function erf(x). The failure rate of a circuit is a 6-sigma failure rate, i.e., P(1)=p_{6-sigma}=(1 in 1.01×10⁹). Let s₁₌₂, s₂₌₃, s₃₌₄, s₄₌₅, . . . , s_{K}=K+1. Then, P(s₁)=p_{3-sigma}=0.135%, P(s₂)=p_{2-sigma}=2.275%, P(s₃)=p_{1.5-sigma}=6.681%, P(s₄)=p_{1.2-sigma}=11.507%, P(s₅)=P_{1-sigma}=15.866%, P(s₆)=p_{6/7-sigma}=19.568%, etc. Here, the sampling error (i.e., the confidence interval) of each input InP(sₖ) used for fitting the SSS curve is zero, and so is the sampling error of true failure rate P(1). (a) When ln P(s₁), ln P(s₂), ln P(s₃), and ln P(s₄) four values are used to fit the SSS curve, after extrapolation to s=1, log₁₀ P_{f} (1)=−9.1272, the error of log₁₀ P_{f}(1) is found to be 1.348%. This translates to P_{f}(1)=7.46×10⁻¹⁰, and the error of P_{f}(1) is −24%. (b) When five ln P(sₖ) values (k=1, 2, 3, 4, 5) values are used to fit the SSS curve, after extrapolation to s=1, log₁₀ P_{f}(1)=−9.1553, the error of log₁₀ P_{f}(1) is found to be 1.660%. This translates to P_{f} (1)=6.99×10⁻¹⁰, and the error of P_{f}(1) is −29%. (c) When six ln P(sₖ) values (k=1, 2, 3, 4, 5, 6) values are used to fit the SSS curve, after extrapolation to s=1, log₁₀ P_{f} (1)=−9.1825, the error of ln P_{f} (1) is found to be 1.961%. This translates to P_{f} (1)=6.57×10⁻¹⁰, and the error of P_{f} (1) is −33%. These relative inaccuracies of log₁₀ P_{f} (1) are summarized in the first data row of Table 401 of FIG. 4A, and these relative inaccuracies of P_{f}(1) are summarized in the first data row of Table 402 of FIG. 4B. Looking at the three examples (a), (b), and (c) together, it is evident that, when the first value s₁ is fixed and the differences (sₖ₊₁−sₖ) are also fixed, as the number of ln P(sₖ) values increases, the relative error of the extrapolated failure probability P_{f} (1) increases significantly when more ln P(sₖ) values are used to fit the SSS curve (from −24% to −29% and to −33%).

One or more embodiments described herein address these and other shortcomings by provide for statistical analysis for predicting rare failure events of a circuit using a modified and improved SSS approach. The modified and improved SSS approach utilizes the following probability scaling relation for calculating the probability of a rare failure:

$$ln {P}_{f} ( s ) = a + b \cdot ln s + \frac{c}{{s}^{2}} + g \cdot s , \qquad ( 1 )$$

where s is a distribution enlargement ratio and a, b, c, and g are fitting parameters.
As is evident, the modified and improved SSS approach adds an additional term (g·s), which introduces an additional fitting parameter g multiplied by the distribution enlargement ratio s.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

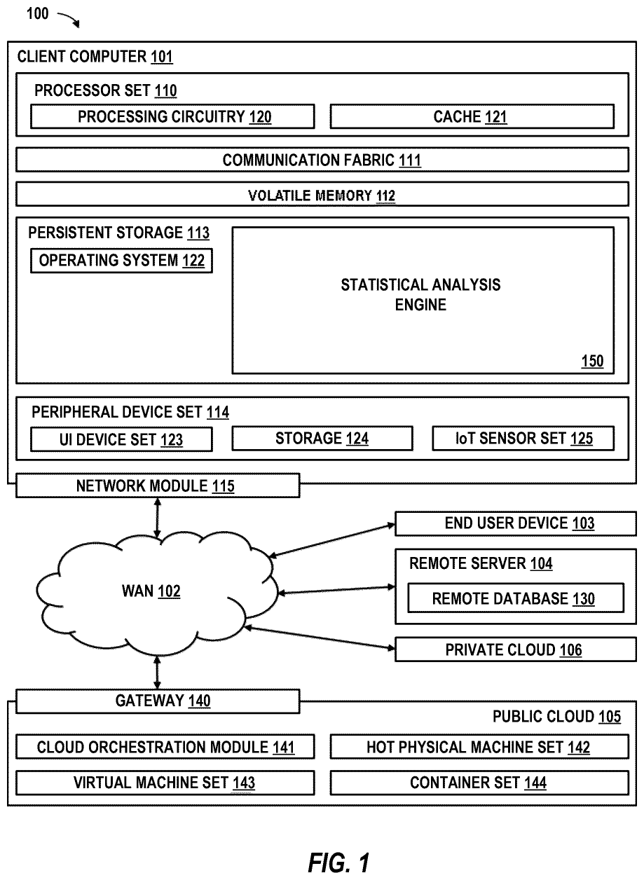

FIG. 1 illustrates a computing environment 100, according to an embodiment. Computing environment 100 contains an example of an environment for the execution of at least some of the computer code involved in performing the inventive methods, such as a statistical analysis engine 150 for predicting rare failure events of a circuit. In addition to the statistical analysis engine 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the statistical analysis engine 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in the statistical analysis engine 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in the statistical analysis engine 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

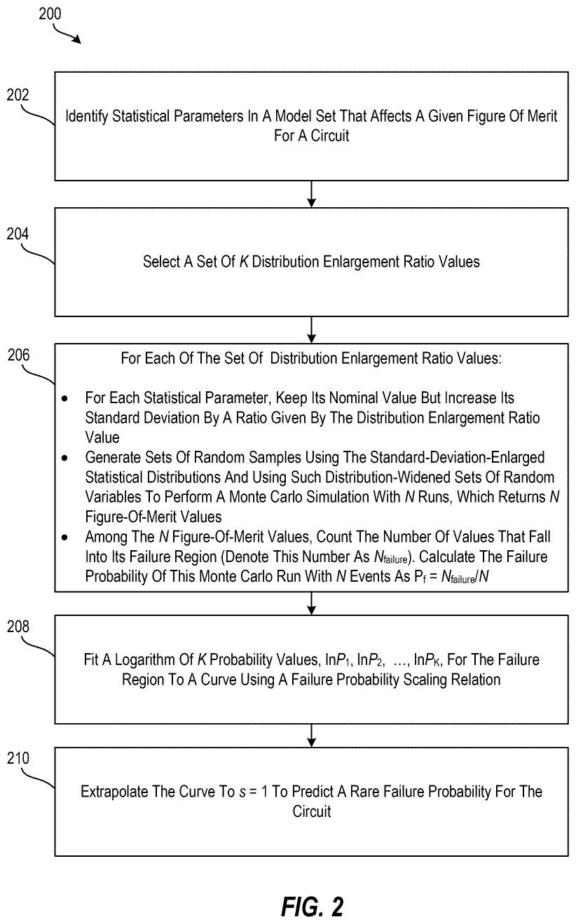

FIG. 2 illustrates a flow diagram of a method 200 for predicting rare failure events of a circuit using statistical analysis, according to an embodiment. The method 200 can be performed by any suitable computing system, device, or environment, such as those described herein. The method 200 is now described with reference to the computing environment 100, and particularly the statistical analysis engine 150, but is not so limited.

At block 202, the statistical analysis engine 150 identifies statistical parameters in a model set that affects a given figure of merit (FOM) for a circuit and labels them as a vector, x=(x₁, x₂, . . . , x_{M})^{T}. A statistical parameter xₘ is characterized as having a mean (or median or nominal) value xₘ₀ and a standard deviation σₘ. As such, the statistical parameters can be expressed as xₘ=xₘ₀+σₘvₘ, m=1, 2, . . . , M. Here, each vₘ is an independent random variable of mean 0 and standard deviation 1. Each random variable vₘ is described by a normalized Gaussian distribution. Collectively, the random variables Um can be denoted in a vector form, v=(v₁, v₂, . . . , v_{M})^{T}.

At block 204, the statistical analysis engine 150 selects a set of K distribution enlargement ratio values s₁, s₂, . . . , sₖ (e.g., 1<s₁<s₂< . . . <s_{K}). According to one or more embodiments, a set of four s values is preferred over a set of five s values, which is preferable over a set of six s values. The difference Δsₖ=sₖ₊₁−sₖ (k=1, 2, . . . , K−1) should be kept relatively small (for example, Δsₖ≤1) but not too small (for example, Δsₖ≥0.25).

At block 206, for each of K distribution enlargement ratio values, the statistical analysis engine 150 performs the following steps. For each statistical parameter (block 202), maintain a nominal value but increase a standard deviation by a ratio given by the K distribution enlargement ratio value. For example, when distributions are Gaussian distribution, the joint probability density function (PDF) is changed from

$${P}^{( t r u e )} ( v ) = \frac{1}{{( 2 π )}^{M / 2}} {\prod }_{m = 1}^{M} exp ( - \frac{1}{2} {v}_{m}^{2} ) to$$

$${P}^{( u s e d )} ( v ) = \frac{1}{{( 2 π )}^{M / 2} {s}_{k}^{M}} {\prod }_{m = 1}^{M} exp ( - \frac{1}{2} {v}_{m}^{2} / {s}_{k}^{2} ) .$$

Next, generate Nₖ sets of random samples using the standard deviation enlarged statistical distribution; perform a Monte Carlo simulation with Nₖ runs using the distribution widened sets of random samples, the Monte Carlo simulation returning Nₖ figure-of-merit (FOM) values. After the Monte Carlo simulation, Nₖ sets of FOM values FOMₙ are determined, where n=1, 2, . . . , NR. Each of the NR FOM values is either in a pass region (e.g., a FOMₙ value passes specifications) or in a failure region (e.g., a FOMₙ value fails specifications). The statistical analysis engine 150 checks whether each of the NR FOM values is in its pass region or its failure region. The statistical analysis engine 150 further counts the number of FOM values FOM (n=1, 2, . . . , Nₖ) that fall into the failure region (denoted as N_{k,failure}), and calculate a failure probability value of this Monte Carlo run with Nₖ events as P_{K}=N_{k,failure}/Nₖ.

At block 208, the statistical analysis engine 150 fits a logarithm of K failure probability values, InP₁, InP₂, . . . , InP_{K}, to a curve defined by the failure probability scaling relation (1) as described herein.

At block 210, the statistical analysis engine 150 extrapolates the curve from block 208 to s=1 to predict a rare failure probability for the circuit. According to one or more embodiments, extrapolating the curve to s=1 leads to a logarithm of the failure probability,

$$ln {P}_{f} ( 1 ) = a + c + g . \qquad ( 2 )$$

The rare failure probability itself for the circuit is now

$${P}_{f} ( 1 ) = exp ( a + c + g ) . \qquad ( 3 )$$

With the addition of last term g in equation (2), the accuracy of ln P_{f}(1) is improved (see the second data row of Table 401) and this translates to a more accurate P_{f}(1) in equation (3) (see the second data row of Table 402).

According to one or more embodiments, the method 200 can include the increasing of the tolerance ranges of evolved statistical parameters so that more sampling points fall into the failure region of the circuit. Examples of the statistical parameters that affect the performance of a circuit include, but are not limited to, the channel lengths of transistors, the widths of transistors, the threshold voltages of transistors, the source and drain resistances of transistors, the gate resistances of transistors, the widths of interconnect wires, the thicknesses of interconnect wires, and/or the like, including combinations and/or multiples thereof. For each of these statistical parameters, its mean stays the same while its tolerance range is artificially increased.

Additional processes also may be included, and it should be understood that the processes depicted in FIG. 2 represent illustrations, and that other processes may be added or existing processes may be removed, modified, or rearranged without departing from the scope of the present disclosure. It should also be understood that the processes depicted in FIG. 2 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

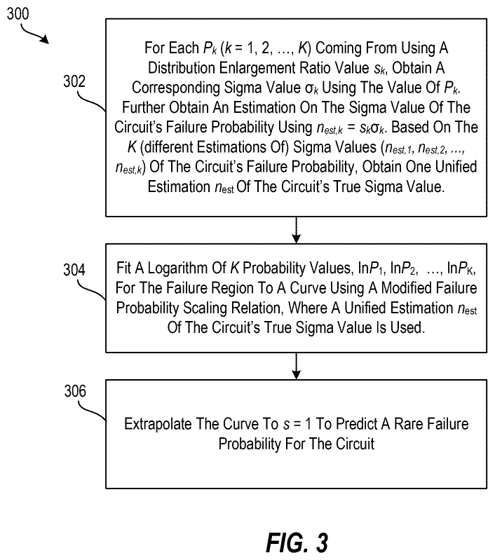

FIG. 3 illustrates a flow diagram of a method 300 for predicting rare failure events of a circuit using statistical analysis, according to an embodiment. The method 300 can be performed by any suitable computing system, device, or environment, such as those described herein. The method 200 is now described with reference to the computing environment 100, and particularly the statistical analysis engine 150, but is not so limited.

According to one or more embodiments, the method 300 is an extension of the method 200 of FIG. 2 through the introduction of a nonlinear relation that maps the distribution enlargement ratio s to a new parameter u:

$$u ( s ) = \frac{s}{s + r \cdot {n}_{est}} , r \approx 0 \text{.35} , \qquad ( 4 )$$

where nₑₛₜ is an estimated circuit's failure probability in terms of number of sigma. When the distribution enlargement ratio s is increased from s=1 to s>>1, u(s) is increased from

$${u}_{1} = \frac{1}{1 + r \cdot {n}_{est}} \qquad ( 5 )$$

toward u=1.

According to one or more embodiments, in the method 300, the steps shown in blocks 202-206 of the method 200 are performed prior to performing the steps shown in the blocks of the method 300. Once the steps of the method 202-206 are performed, the method 300 proceeds at block 302.

Particularly, at block 302, the statistical analysis engine 150 performs the following: For each Pₖ(k=1, 2, . . . , K) coming from using a distribution enlargement ratio value sₖ, the statistical analysis engine 150 first obtains a corresponding sigma value σₖ using Pₖ itself, and then obtains failure probability's sigma value of the circuit using n_{est,k}=σₖsₖ. Based on the K (different estimations of) sigma values (n_{est,1}, n_{est,2}) . . . , n_{est,k}) of the circuit's failure probability, the statistical analysis engine 150 obtains a unified estimation nₑₛₜ of the circuit's true sigma value. For example, if a Monte Carlo simulation with sₖ=2 gives a failure probability Pₖ=0.135%, then it is known that this particular Monte Carlo simulation (with sₖ=2) yields a 3-sigma failure probability, σₖ=3, and thus n_{est,k}=σₖsₖ=6. Another example: If a Monte Carlo simulation with sₖ=2.5 gives a failure probability Pₖ=0.135%, then it is known that this particular Monte Carlo simulation (with sₖ=2.5) yields a 3-sigma failure probability, σₖ=3, and thus n_{est,k}=σₖsₖ=5. Based on values n_{est, 1}=σ₁s₁, n_{est,2}=σ₂s₂, . . . , n_{est,K}=σ_{K}s_{K}, the statistical analysis engine 150 obtains an estimation of the circuit's total sigma value nₑₛₜ. For example, nₑₛₜ is an average or a median of nₑₛₜ, 1′ n_{est,2}, . . . , n_{est,K}, or approximate nₑₛₜ to one of n_{est,k} (k=1, 2, . . . , K). At this point, it is noted that the ratio of s_{K}/s₁ is large when compared to one (using the stated convention s₁<s₂< . . . <s_{K}) and so is the ratio of σ₁/σ_{K}. But the ratio of max{σ₁s₁, σ₂s₂, . . . , σ_{K}s_{K}} over min {σ₁s₁, σ₂s₂, . . . , σ_{K}s_{K}} is close to one.

At block 304, the statistical analysis engine 150 fits the logarithm of K probability values P for the failure region, InP₁, InP₂, . . . , InP_{K}, to a curve defined as a modified failure probability scaling relation, where a unified estimation nₑₛₜ of the circuit's true sigma value is used. Then at block 306, the statistical analysis engine 150 extrapolates the curve from block 304 (e.g., based on the modified version of the probability scaling relation) to s=1 to predict a rare failure probability for the circuit.

According to one or more embodiments, the modified version of the probability scaling relation (block 304) is as follows:

$$ln {P}_{f} ( s ) = a + b \cdot ln u ( s ) + \frac{c}{{s}^{2}} + g \cdot u ( s ) . \qquad ( 6 )$$

Extrapolating probability scaling relation (6) to s=1, a logarithm of the failure probability is obtained,

$$ln {P}_{f} ( 1 ) = a + b \cdot ln {u}_{1} + c + g \cdot {u}_{1} . \qquad ( 7 )$$

Then, the rare failure probability for the circuit is predicted using the following equation,

$${P}_{f} ( 1 ) = exp ( a + b \cdot ln {u}_{1} + c + g \cdot {u}_{1} ) . \qquad ( 8 )$$

With the addition of last term (g·u₁) in equation (7), the accuracy of ln P_{f}(1) is further improved (see the third data row of Table 401) and this translates to a more accurate P_{f} (1) in equation (8) (see the third data row of Table 402).

According to one or more embodiments, the modified version of the probability scaling relation (block 304) is as follows:

$$ln {P}_{f} ( s ) = a + b \cdot ln u ( s ) + \frac{c}{{s}^{2}} + g \cdot u ( s ) \cdot {T}_{2} ( u ( s ) ) . \qquad ( 9 )$$

The function T₂(u) is a quadratic polynomial of variable u and can be defined as follows:

$${T}_{2} ( u ) = {h}_{0} + {h}_{1} u + {h}_{2} {u}^{2} , {h}_{1} \approx 0.8 {h}_{0} , {h}_{2} \approx - 0.4 {h}_{0} . \qquad ( 10 )$$

Extrapolating probability scaling relation (9) to s=1, one arrives at a logarithm of the failure probability,

$$ln {P}_{f} ( 1 ) = a + b \cdot ln {u}_{1} + c + g \cdot {u}_{1} \cdot {T}_{2} ( {u}_{1} ) . \qquad ( 11 )$$

Then, the rare failure probability for the circuit is predicted using the following equation,

$${P}_{f} ( 1 ) = exp ( a + b \cdot ln {u}_{1} + c + g \cdot {u}_{1} \cdot {T}_{2} ( {u}_{1} ) ) . \qquad ( 12 )$$

With the addition of last term (g·u₁·T₂(u₁)) in equation (11), the accuracy of ln P_{f} (1) is further improved (see the fourth data row of Table 401) and this translates to a more accurate P_{f} (1) in equation (12) (see the fourth data row of Table 402).

According to one or more embodiments, the modified version of the probability scaling relation (block 304) is as follows:

$$ln {P}_{f} ( s ) = a + b \cdot ln u ( s ) + \frac{c}{{s}^{2}} + g \cdot u ( s ) \cdot {T}_{8} ( u ( s ) ) . \qquad ( 13 )$$

The function T₈(u) is a polynomial in u of degree eight and can be defined as follows:

$${T}_{8} ( u ) = {\sum }_{n = 0}^{8} {h}_{n} {u}^{n} , {h}_{1} \approx 0.4 {h}_{0} , {h}_{2} \approx 0.1 {h}_{0} , {h}_{3} \approx - 0.2 {h}_{0} , {h}_{4} \approx 0.3 {h}_{0} , {h}_{5} \approx - 1.1 {h}_{0} , {h}_{6} \approx 1.5 {h}_{0} , {h}_{7} \approx - 0.8 {h}_{0} , {h}_{8} \approx 0.2 {h}_{0} . \qquad ( 14 )$$

Extrapolating probability scaling relation (13) to s=1, a logarithm of the rare failure probability is expressed as:

$$ln {P}_{f} ( 1 ) = a + b \cdot ln {u}_{1} + c + g \cdot {u}_{1} \cdot {T}_{8} ( {u}_{1} ) . \qquad ( 15 )$$

Then, the rare failure probability for the circuit is predicted using the following equation,

$${P}_{f} ( 1 ) = exp ( a + b \cdot ln {u}_{1} + c + g \cdot {u}_{1} \cdot {T}_{8} ( {u}_{1} ) ) . \qquad ( 16 )$$

With the addition of last term (g·u₁·T₈(u₁)) in equation (15), the accuracy of ln P_{f}(1) is greatly improved (see the last row of Table 401) and this translates to a very accurate P_{f} (1) in equation (16) (see the last row of Table 402).

Additional processes also may be included, and it should be understood that the processes depicted in FIG. 3 represent illustrations, and that other processes may be added or existing processes may be removed, modified, or rearranged without departing from the scope of the present disclosure. It should also be understood that the processes depicted in FIG. 3 may be implemented as programmatic instructions stored on a non-transitory computer-readable storage medium that, when executed by a processor (e.g., the processor set 110, the processing circuitry 120) of a computing system (e.g., the computer 101), cause the processor to perform the processes described herein.

According to one or more embodiments, one or more of the techniques described herein, such as the method 200 and/or the method 300, for performing statistical analysis of a circuit using a modified and improved scaled sigma sampling, can be applied to a setting, perspective, intervention, comparison, and evaluation (SPICE) simulation or in other exploratory data analysis (EDA) statistical tools.

While the foregoing is directed to embodiments of the present disclosure, other and further embodiments of the present disclosure may be devised without departing from the basic scope thereof, and the scope thereof is determined by the claims that follow.

What is claimed is:

1. A computer-implemented method comprising:
identifying statistical parameters in a model set that affects a given figure of merit for a circuit;
selecting a set of K distribution enlargement ratio values s₁, s₂, . . . , sₖ;
for each of the set of K distribution enlargement ratio values:
for each identified statistical parameter, maintain a nominal value and increase a standard deviation by a ratio given by the said distribution enlargement ratio value to generate a standard deviation enlarged statistical distribution;
generating sets of random samples using the standard deviation enlarged statistical distributions and performing a Monte Carlo simulation with N runs using distribution-widened sets of random samples, which returns N figure-of-merit values; and
among the N figure-of-merit values, count a number of figure-of-merit values that fall into a failure region, and calculate a failure probability value of the Monte Carlo run with N events;
fitting a logarithm of K failure probability values P for the failure region, InP₁, InP₂, . . . , InP_{K}, to a curve defined by a probability scaling relation:
$$ln {P}_{f} ( s ) = a + b \cdot ln s + \frac{c}{{s}^{2}} + g \cdot s ,$$
where s is a distribution enlargement ratio and a, b, c, and g are fitting parameters; and
extrapolating the curve to s=1 to predict a rare failure probability for the circuit.

2. The computer-implemented method of claim 1, wherein extrapolating the curve to s=1 further comprises obtain the following value to predict a logarithm of the rare failure probability for the circuit:
$$ln {P}_{f} ( 1 ) = a + c + g .$$

3. The computer-implemented method of claim 1, wherein extrapolating the curve to s=1 further comprises obtain the following value to predict the rare failure probability for the circuit:
$${P}_{f} ( 1 ) = exp ( a + c + g ) .$$

4. The computer-implemented method of claim 1, wherein fitting the logarithm of K failure probability values P is further based on through a non-linear relation defined by the following expression:
$$u ( s ) = \frac{s}{s + r \cdot {n}_{est}} , r \approx 0.35 ,$$
where nₑₛₜ is an estimated failure probability for the circuit in terms of a number of sigma.

5. The computer-implemented method of claim 4, wherein the probability scaling relation is modified as follows:
$$ln {P}_{f} ( s ) = a + b \cdot ln u ( s ) + \frac{c}{{s}^{2}} + g \cdot u ( s ) .$$

6. The computer-implemented method of claim 4, wherein the probability scaling relation is modified as follows:
$$ln {P}_{f} ( s ) = a + b \cdot ln u ( s ) + \frac{c}{{s}^{2}} + g \cdot u ( s ) \cdot {T}_{2} ( u ( s ) ) ,$$
where T₂(u) is a proper polynomial in u of degree two.

7. The computer-implemented method of claim 4, wherein the probability scaling relation is modified as follows:
$$ln {P}_{f} ( s ) = a + b \cdot ln u ( s ) + \frac{c}{{s}^{2}} + g \cdot u ( s ) \cdot {T}_{8} ( u ( s ) ) ,$$
where T₈(u) is a proper polynomial in u of degree eight.

8. The computer-implemented method of claim 1, further comprising:
estimating a sigma value of the rare failure probability of the circuit using K failure probability values P₁, P₂, . . . , P_{K}, and corresponding distribution enlargement ratios; and
using the estimated sigma value of the rare failure probability in a subsequent probability scaling relation, curve fitting, and extrapolation.

9. A system comprising:
a memory comprising computer readable instructions; and
a processing device for executing the computer readable instructions, the computer readable instructions controlling the processing device to perform operations comprising:
identifying statistical parameters in a model set that affects a given figure of merit for a circuit;
selecting a set of K distribution enlargement ratio values s₁, s₂, . . . , sₖ;
for each of the set of K distribution enlargement ratio values:
for each identified statistical parameter, maintain a nominal value and increase a standard deviation by a ratio given by the said distribution enlargement ratio value to generate a standard deviation enlarged statistical distribution;
generating sets of random samples using the standard deviation enlarged statistical distributions and performing a Monte Carlo simulation with N runs using distribution-widened sets of random samples, which returns N figure-of-merit values; and
among the N figure-of-merit values, count a number of figure-of-merit values that fall into a failure region, and calculate a failure probability value of the Monte Carlo run with N events;
fitting a logarithm of K failure probability values P for the failure region, InP₁, InP₂, . . . , InP_{K}, to a curve defined by a probability scaling relation:
$$ln {P}_{f} ( s ) = a + b \cdot ln s + \frac{c}{{s}^{2}} + g \cdot s ,$$
where s is a distribution enlargement ratio and a, b, c, and g are fitting parameters; and
extrapolating the curve to s=1 to predict a rare failure probability for the circuit.

10. The system of claim 9, wherein extrapolating the curve to s=1 further comprises obtain the following value to predict a logarithm of the rare failure probability for the circuit:
$$ln {P}_{f} ( 1 ) = a + c + g .$$

11. The system of claim 9, wherein extrapolating the curve to s=1 further comprises obtain the following value to predict the rare failure probability for the circuit:
$${P}_{f} ( 1 ) = exp ( a + c + g ) .$$

12. The system of claim 9, wherein fitting the logarithm of K failure probability values P is further based on through a non-linear relation defined by the following expression:
$$u ( s ) = \frac{s}{s + r \cdot {n}_{est}} , r \approx 0.35 ,$$
where nₑₛₜ is an estimated failure probability for the circuit in terms of a number of sigma.

13. The system of claim 12, wherein the probability scaling relation is modified as follows:
$$ln {P}_{f} ( s ) = a + b \cdot ln u ( s ) + \frac{c}{{s}^{2}} + g \cdot u ( s ) .$$

14. The system of claim 12, wherein the probability scaling relation is modified as follows:
$$ln {P}_{f} ( s ) = a + b \cdot ln u ( s ) + \frac{c}{{s}^{2}} + g \cdot u ( s ) \cdot {T}_{2} ( u ( s ) ) ,$$
where T₂(u) is a proper polynomial in u of degree two.

15. The system of claim 12, wherein the probability scaling relation is modified as follows:
$$ln {P}_{f} ( s ) = a + b \cdot ln u ( s ) + \frac{c}{{s}^{2}} + g \cdot u ( s ) \cdot {T}_{8} ( u ( s ) ) ,$$
where T₈(u) is a proper polynomial in u of degree eight.

16. The system of claim 9, wherein the operations further comprise:
estimating a sigma value of the rare failure probability of the circuit using K failure probability values P₁, P₂, . . . , P_{K}, and corresponding distribution enlargement ratios; and
using the estimated sigma value of the rare failure probability in a subsequent probability scaling relation, curve fitting, and extrapolation.

17. A computer program product comprising:
a set of one or more computer-readable storage media;
program instructions, collectively stored in the set of one or more storage media, for causing a processor set to perform the following computer operations:
identifying statistical parameters in a model set that affects a given figure of merit for a circuit;
selecting a set of K distribution enlargement ratio values s₁, s₂, . . . , sₖ;
for each of the set of K distribution enlargement ratio values:
for each identified statistical parameter, maintain a nominal value and increase a standard deviation by a ratio given by the said distribution enlargement ratio value to generate a standard deviation enlarged statistical distribution;
generating sets of random samples using the standard deviation enlarged statistical distributions and performing a Monte Carlo simulation with N runs using distribution-widened sets of random samples, which returns N figure-of-merit values; and
among the N figure-of-merit values, count a number of figure-of-merit values that fall into a failure region, and calculate a failure probability value of the Monte Carlo run with N events;
fitting a logarithm of K failure probability values P for the failure region, InP₁, InP₂, . . . , InP_{K}, to a curve defined by a probability scaling relation:
$$ln {P}_{f} ( s ) = a + b \cdot ln s + \frac{c}{{s}^{2}} + g \cdot s ,$$
where s is a distribution enlargement ratio and a, b, c, and g are fitting parameters; and
extrapolating the curve to s=1 to predict a rare failure probability for the circuit.

18. The computer program product of claim 17, wherein extrapolating the curve to S=1 further comprises obtain the following value to predict a logarithm of the rare failure probability for the circuit:
$$ln {P}_{f} ( 1 ) = a + c + g .$$

19. The computer program product of claim 17, wherein extrapolating the curve to S=1 further comprises obtain the following value to predict the rare failure probability for the circuit:
$${P}_{f} ( 1 ) = exp ( a + c + g ) .$$

20. The computer program product of claim 17, wherein fitting the logarithm of K failure probability values P is further based on through a non-linear relation defined by the following expression:
$$u ( s ) = \frac{s}{s + r \cdot {n}_{est}} , r \approx 0.35 ,$$
where nₑₛₜ is an estimated failure probability for the circuit in terms of a number of sigma.
